(19) United States
(12) Patent Application Publication
(10) Pub. No.: US 2023/0053518 A1
(43) Pub. Date: Feb. 23, 2023

(54) ASSEMBLY FOR A BRAKE BOOSTER AND BRAKE BOOSTER

(71) Applicant: ZF Active Safety GmbH, Koblenz (DE)

(72) Inventors: Abdallah Ibrahim, Urmitz (DE); Paul Warkentin, Bonefeld (DE); José Manuel Calvo Martinez, Kurft (DE); Iosu Oloriz del Rosario, Koblenz (DE); Jorge Trobajo, Mutilva (Navarra) (ES); Carlos Erviti, Monreal (Navarra) (ES)

(21) Appl. No.: 17/892,366

(22) Filed: Aug. 22, 2022

(30) Foreign Application Priority Data
Aug. 20, 2021 (DE) 102021121704.0

(51) Int. Cl. B60T 13/74; B60T 13/16; F16D 1/112

(52) U.S. Cl. CPC B60T 13/745; B60T 13/162; F16D 1/112; F16D 2001/103

(57) ABSTRACT

An assembly for a brake booster, for example, an electromechanical brake booster, comprises a motor output shaft of an electric motor, a transmission input shaft of a transmission which can be coupled to the electric motor, and a coupling element for power-transmitting coupling of the motor output shaft to the transmission input shaft. The coupling element has internal toothing which can be operatively connected or is operatively connected to the motor output shaft and to the transmission input shaft, as well as a brake booster with an assembly.

### CROSS-REFERENCE TO RELATED APPLICATION

This application claims priority to German Patent Application No. 102021121704.0, filed Aug. 20, 2021, the disclosure of which is incorporated herein by reference in its entirety.

### TECHNICAL FIELD

The disclosure relates to an assembly for a brake booster of a vehicle. The disclosure furthermore relates to a brake booster, in particular an electromechanical brake booster, for a vehicle.

### BACKGROUND

Vehicle brake systems often have electromechanical brake boosters (electronic brake boosters, EBB, EBB actuators), in which the energy is produced electrically by an electric motor and is transmitted by a transmission. WO 2014/177691 A1, for example, discloses a brake system having a master cylinder and an electric servo brake with transmission of the movement of the electric motor to a push rod of the master cylinder by two mechanisms, which are symmetrical with respect to the axis of the system, for transmitting the movement of the electric motor to two toothed racks of a body of the electric servo brake.

It has been found that it is precisely the assembly and connection between the motor output shaft and the transmission input shaft which is very complex and susceptible to errors owing to the connecting elements. This results in poor alignment of the shafts and reduced torque transmission. This can lead to failure of the electromechanical brake booster and thus of the brake system.

### SUMMARY

Accordingly, what is needed is to structurally and/or functionally improve an assembly mentioned at the outset. Furthermore, what is also needed is to structurally and/or functionally improve a brake booster mentioned at the outset.

The object is achieved by means of an assembly having the features of Claim 1. In addition, the object is achieved by means of a brake booster having the features of Claim 22. Advantageous embodiments and/or developments form the subject matter of the dependent claims.

An assembly can be for a brake booster. The brake booster can be for a vehicle. The brake booster can be an electromechanical brake booster. The vehicle can be a motor vehicle. The motor vehicle can be a passenger car or a heavy goods vehicle.

The assembly can comprise a motor output shaft. The motor output shaft can be the output shaft of a motor, such as an electric motor, of the brake booster.

The assembly can comprise a transmission input shaft. The transmission input shaft can be the input shaft of a transmission of the brake booster. The transmission input shaft can be a transmission input shaft of a transmission which can be coupled to the electric motor, for example in a power-transmitting manner. The transmission input shaft can be couplable to the motor, such as an electric motor, and/or to the motor output shaft, for example in a power-transmitting manner. The motor output shaft can be couplable to the transmission and/or to the transmission input shaft, for example in a power-transmitting manner. The transmission can be couplable to the motor, such as an electric motor, for example in a power-transmitting manner. The transmission input shaft can have a screw wheel, such as a screw gear wheel. The screw wheel can be supported by the transmission input shaft and/or arranged on the transmission input shaft and/or connected, for example connected for conjoint rotation, to the transmission input shaft. The screw wheel can be fitted onto the transmission input shaft. The screw wheel can be formed integrally with the transmission input shaft, i.e. the transmission input shaft and the screw wheel can be produced from a single part.

The assembly can comprise a coupling element for the power-transmitting coupling of the motor output shaft to the transmission input shaft. The coupling element can have internal toothing. The internal toothing of the coupling element can be operatively connectable or operatively connected to the motor output shaft and to the transmission input shaft. The internal toothing of the coupling element can be in engagement or can be brought into engagement with the motor output shaft and with the transmission input shaft. The internal toothing of the coupling element can be longitudinal toothing and/or spline toothing. The internal toothing of the coupling element can have straight toothing or oblique toothing. The internal toothing of the coupling element can have a multiplicity of tooth elements. The tooth elements of the internal toothing of the coupling element can each extend in the axial direction, for example with respect to a centre axis and/or axis of rotation of the coupling element. The tooth elements of the internal toothing of the coupling element can extend in the radial direction, for example radially inwards and/or with respect to the centre axis and/or axis of rotation of the coupling element, in each case from a tooth root to a tooth tip. The tooth elements of the internal toothing of the coupling element can be of substantially trapezoidal and/or triangular design in cross section.

The motor output shaft can have external toothing, at least in some section or sections. The transmission input shaft can have external toothing, at least in some section or sections. The external toothing of the motor output shaft and/or the external toothing of the transmission input shaft can be of complementary design to the internal toothing of the coupling element. The external toothing of the motor output shaft and/or the external toothing of the transmission input shaft can be shaft splines and/or spline toothing. The external toothing of the motor output shaft and/or the external toothing of the transmission input shaft can be longitudinal toothing. The external toothing of the motor output shaft and/or the external toothing of the transmission input shaft can have a multiplicity of tooth elements. The tooth elements of the respective external toothing can each extend in the axial direction, for example with respect to a centre axis and/or axis of rotation of the motor output shaft or transmission input shaft. The tooth elements of the respective external toothing can extend in the radial direction, for example radially outwards and/or with respect to the centre axis and/or axis of rotation of the motor output shaft or transmission input shaft, in each case from a tooth root to a tooth tip. The tooth elements of the respective external toothing can be of substantially trapezoidal and/or triangular design in cross section.

The internal toothing of the coupling element can be of complementary design to the external toothing of the motor output shaft and/or to the external toothing of the transmission input shaft. The internal toothing of the coupling element can be in engagement or can be brought into engagement with the external toothing of the motor output shaft and/or the external toothing of the transmission input shaft. The coupling element and/or its internal toothing can be designed to transmit a moment, such as torque, from the motor output shaft to the transmission input shaft.

The coupling element can be designed as a sleeve, such as a coupling sleeve. The coupling element or the sleeve/coupling sleeve can have an axial through-hole. The internal toothing of the coupling element can be arranged in the through-hole. The internal toothing of the coupling element can be arranged on the inside diameter of the through-hole.

The transmission input shaft can have an end section. The end section of the transmission input shaft can have the external toothing of the transmission input shaft. The end section of the transmission input shaft can be introducible or introduced at least partially into the through-hole of the coupling element, for example at a first end face of the coupling element. The end section of the transmission input shaft can be insertable or inserted at least partially into the through-hole of the coupling element. In this case, the external toothing of the transmission input shaft and the internal toothing of the coupling element can be coupled and/or brought into engagement in a power-transmitting manner, for example.

The motor output shaft can have an end section. The end section of the motor output shaft can have the external toothing of the motor output shaft. The end section of the motor output shaft can be introducible or introduced at least partially into the through-hole of the coupling element, for example at a second end face of the coupling element lying opposite the first end face. The end section of the motor output shaft can be insertable or inserted at least partially into the through-hole of the coupling element. In this case, the external toothing of the motor output shaft and the internal toothing of the coupling element can be coupled and/or brought into engagement in a power-transmitting manner, for example.

The coupling element can be arranged or arrangeable substantially between the motor output shaft and the transmission input shaft in the axial direction.

The assembly can comprise a centring element for centring and/or aligning the motor output shaft and the transmission input shaft with respect to one another.

The centring element can be arranged or arrangeable substantially between the motor output shaft and the transmission input shaft in the axial direction. The centring element can be arranged or arrangeable substantially between the motor output shaft and the coupling element in the axial direction. The centring element can be arranged or arrangeable substantially between the transmission input shaft and the coupling element in the axial direction.

The centring element can have internal toothing. The internal toothing of the centring element can be operatively connectable or operatively connected to the motor output shaft or to the transmission input shaft. The internal toothing of the centring element can be in engagement or can be brought into engagement with the motor output shaft or with the transmission input shaft. The internal toothing of the centring element can be longitudinal toothing and/or spline toothing. The internal toothing of the centring element can have straight toothing or oblique toothing. The internal toothing of the centring element can have a multiplicity of tooth elements. The tooth elements of the internal toothing of the centring element can each extend in the axial direction, for example with respect to a centre axis and/or axis of rotation of the centring element. The tooth elements of the internal toothing of the centring element can extend in the radial direction, for example radially inwards and/or with respect to the centre axis and/or axis of rotation of the centring element, in each case from a tooth root to a tooth tip. The tooth elements of the internal toothing of the centring element can be of substantially trapezoidal and/or triangular design in cross section.

The internal toothing of the centring element can be in engagement or can be brought into engagement with the external toothing of the motor output shaft or with the external toothing of the transmission input shaft. The internal toothing of the centring element can be of complementary design to the external toothing of the motor output shaft and/or to the external toothing of the transmission input shaft and/or to the internal toothing of the coupling element.

The centring element can be designed as a sleeve, such as a centring sleeve. The centring element or the sleeve/centring sleeve can have an axial through-hole. The internal toothing of the centring element can be arranged in the through-hole. The internal toothing of the centring element can be arranged on the inside diameter of the through-hole.

The end section of the motor output shaft having the external toothing can be capable of being passed or can be passed through the through-hole of the centring element. The end section of the transmission input shaft having the external toothing can be capable of being passed or can be passed through the through-hole of the centring element.

The centring element can have a centring structure, e.g. in an axial end region. In an axial end region, for example, the coupling element can have a counter-centring structure which interacts with and/or corresponds to the centring structure of the centring element. The centring structure and the counter-centring structure can be of complementary design to one another. The two axial end regions of the centring element and of the coupling element can be arranged opposite one another in the axial direction and/or can be aligned with one another. The centring structure of the centring element and the counter-centring structure of the coupling element can be arranged opposite one another and/or can be aligned with one another in the axial direction.

The centring structure and/or the counter-centring structure can be designed to effect centring and/or alignment in the radial and/or axial direction and/or in the circumferential direction, for example of the coupling element and/or of the centring element and/or of the motor output shaft and/or of the transmission input shaft. The centring structure and/or the counter-centring structure can be designed to centre and/or align the motor output shaft and the transmission input shaft with respect to one another. The centring structure and/or the counter-centring structure can be designed to effect centring and/or alignment in the radial and/or axial direction and/or in the circumferential direction, thus ensuring that the motor output shaft is centred and/or aligned with respect to the transmission input shaft and/or that the transmission input shaft is centred and/or aligned with respect to the motor output shaft.

The centring structure and the counter-centring structure can engage in one another substantially in the axial direction. The centring structure and the counter-centring structure can be displaced at least partially one inside the other substantially in the axial direction.

The centring structure and/or the counter-centring structure can have a tooth structure and/or wedge structure. The tooth structure and/or wedge structure can be designed to effect centring and/or alignment in the axial direction and/or in the circumferential direction. The centring structure and/or the counter-centring structure can be of tooth-shaped and/or wedge-shaped and/or crown-shaped design. The tooth structure can have a plurality of teeth. The wedge structure can have a plurality of wedges. The teeth of the tooth structure and/or the wedges of the wedge structure can each extend and/or be aligned substantially in the axial direction.

The centring structure can have an inside diameter. The counter-centring structure can have an outside diameter. The inside diameter of the centring structure and the outside diameter of the counter-centring structure can be designed to effect centring and/or alignment in the radial direction.

The assembly can have a spring element. The spring element can be a spring, such as a helical spring and/or a compression spring. The spring element can be arranged effectively between the centring element and the motor output shaft in the axial direction. The spring element can be arranged effectively between the centring element and the transmission input shaft in the axial direction. On the one hand, the spring element can be supported on a shoulder of the motor output shaft or transmission input shaft and/or can be arranged there with a first contact section, for example bearing against it. On the other hand, the spring element can be supported on the centring element on the other side and/or can be arranged there with a second contact section, for example bearing against it. The spring element can be designed to make the centring element project partially beyond the end section of the motor output shaft or beyond the end section of the transmission input shaft, for example in a resilient manner.

Unless otherwise specified, or unless the context otherwise requires, the indications “axial” and “radial” may refer to a direction of extent of the axis, such as the centre axis or axis of rotation, of the motor output shaft and/or of the transmission input shaft and/or of the coupling element and/or of the centring element. “Axial” then corresponds to a direction of extent of the axis, such as the centre axis or the axis of rotation. “Radial” is then a direction which is perpendicular to the direction of extent of the axis, such as the centre axis or axis of rotation, and intersects with the axis, such as the centre axis or axis of rotation. “In the circumferential direction” then corresponds to a circular arc direction about the axis, such as the centre axis or axis of rotation.

A brake booster can be for a vehicle. The brake booster can be an electromechanical brake booster. The vehicle can be a motor vehicle. The motor vehicle can be a passenger car or a heavy goods vehicle. The brake booster can have a motor, such as an electric motor. The brake booster can have a push rod. The brake booster can have a transmission. The brake booster can have an assembly. The assembly can be arranged effectively between the electric motor and the transmission. The assembly can be designed as described above and/or below.

The brake booster can enable electrically controlled intervention in a brake actuation and/or can be designed for this purpose. The brake booster can be used and/or designed to boost a brake pedal force. The brake booster can act in the direction of a brake pedal force. The brake booster can be used and/or designed to actuate a brake independently of a brake pedal force. The brake booster can be used and/or designed to attenuate a brake pedal force. The brake booster can act counter to a brake pedal force. The brake booster can be used and/or designed to simulate a brake pedal force. The brake booster can be used and/or designed to actuate a brake in an automated or partially automated manner. The brake booster can allow purely mechanical actuation of a brake by a brake pedal.

The vehicle, such as a motor vehicle, can have at least one engine for a travel drive. The vehicle can have at least one drivable vehicle wheel. The vehicle can have at least one braking device. The at least one braking device can be used and/or designed to brake at least one vehicle wheel. The at least one braking device can be a parking brake device. The at least one braking device can be a service brake device. The at least one braking device can be a dual-circuit or multi-circuit braking device. The at least one braking device can be a hydraulic braking device. The at least one braking device can have a brake master cylinder. The at least one braking device can have the brake booster. The at least one braking device can have a brake pedal, a brake fluid reservoir, a brake pressure distributor, a pipe system, brake hoses, wheel brake cylinders and/or bleed valves.

With the disclosure, assembly and connection between the motor output shaft and the transmission input shaft can be simplified and improved. The susceptibility to errors can be significantly reduced. The alignment of the motor output shaft and the transmission input shaft can be improved. Operational safety can be increased and/or fail safety can be improved.

### BRIEF DESCRIPTION OF DRAWINGS

Exemplary arrangements of the disclosure are described in greater detail below with reference to figures, which are schematic and illustrative and of which:

FIG. 1 shows a first view of an assembly having a coupling element;

FIG. 2 shows a second view of the assembly according to FIG. 1;

FIG. 3 shows a third view of the assembly according to FIG. 1;

FIG. 4 shows a fourth view of the assembly according to FIG. 1;

FIG. 5 shows a fifth view of the assembly according to FIG. 1;

FIG. 6 shows a sectional view of the assembly according to FIG. 1;

FIG. 7 shows a first view of an assembly having a coupling element and a centering element;

FIG. 8 shows a second view of the assembly according to FIG. 7;

FIG. 9 shows a third view of the assembly according to FIG. 7;

FIG. 10 shows a fourth view of the assembly according to FIG. 7;

FIG. 11 shows a fifth view of the assembly according to FIG. 7; and

FIG. 12 shows a sectional view of the assembly according to FIG. 7.

### DETAILED DESCRIPTION

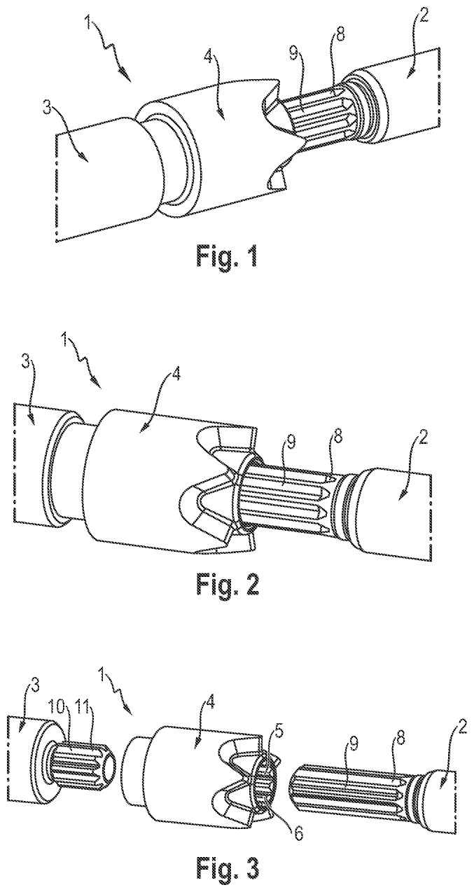

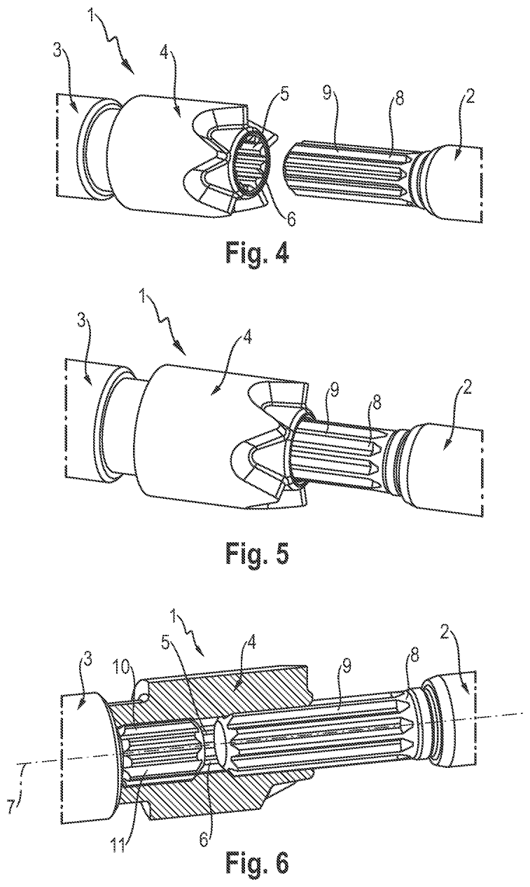

FIGS. 1 to 6 show various views of an assembly 1 for a brake booster, in particular for an electromechanical brake booster.

The assembly 1 comprises a motor output shaft 2 of an electric motor of the brake booster, a transmission input shaft 3 of a transmission of the brake booster, which can be coupled to the electric motor, and a coupling element 4 for power-transmitting coupling of the motor output shaft 2 to the transmission input shaft 3. The coupling element 4 is designed as a sleeve, such as a coupling sleeve, and has, in a through-hole 5, internal toothing 6, which can be operatively connected or is operatively connected to the motor output shaft 2 and to the transmission input shaft 3. With respect to the centre axis 7, the coupling element 4 is arranged substantially between the motor output shaft 2 and the transmission input shaft 3 in the axial direction.

The internal toothing 6 of the coupling element 4 is spline toothing extending in the axial direction with respect to a centre axis 7. The internal toothing 6 of the coupling element 4 has a multiplicity of tooth elements which, with respect to the centre axis 7, extend radially inwards in the radial direction in each case from a tooth root to a tooth tip and are of substantially trapezoidal and/or triangular design in cross section.

The motor output shaft 2 has an end section 8 with external toothing 9. The transmission input shaft 3 has an end section 10 with external toothing 11. The external toothing 9 of the motor output shaft 2 and the external toothing 11 of the transmission input shaft 3 are of complementary design to the internal toothing 6 of the coupling element 4.

The external toothing 9 of the motor output shaft 2 and the external toothing 11 of the transmission input shaft 3 are spline teeth extending in the axial direction with respect to the centre axis 7. The external toothing 9 of the motor output shaft 2 and the external toothing 11 of the transmission input shaft 3 each have a multiplicity of tooth elements which, with respect to the centre axis 7, extend radially outwards in the radial direction in each case from a tooth root to a tooth tip and are of substantially trapezoidal and/or triangular design in cross section.

The end section 10 of the transmission input shaft 3, which has the external toothing 11, can be introduced or is introduced at least partially into the through-hole 5 of the coupling element 4 at a first end face of the coupling element 4. The end section 8 of the motor output shaft 2, which has the external toothing 9, can be introduced or is introduced at least partially into the through-hole 5 of the coupling element 4 at a second end face of the coupling element 4 lying opposite the first end face. The internal toothing 6 of the coupling element 4 is in engagement or can be brought into engagement with the external toothing 9 of the motor output shaft 2 and the external toothing 11 of the transmission input shaft 3. The coupling element 4 and its internal toothing 6 are designed to transmit a moment, such as torque, from the motor output shaft 2 to the transmission input shaft 3.

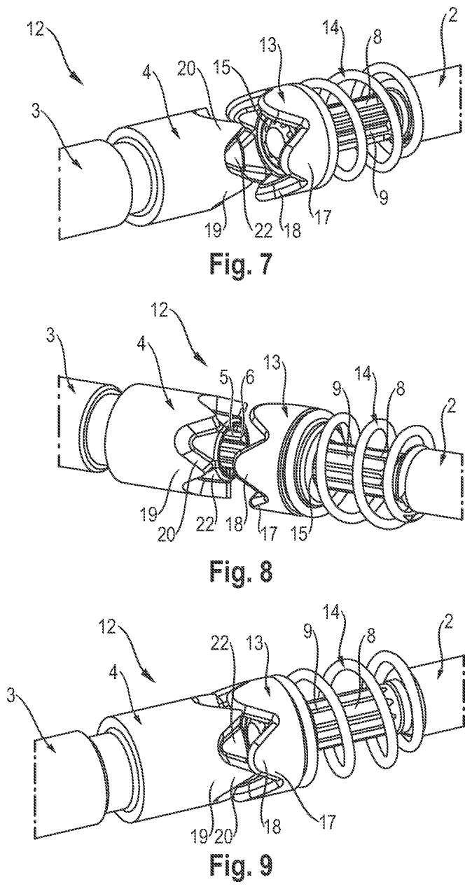

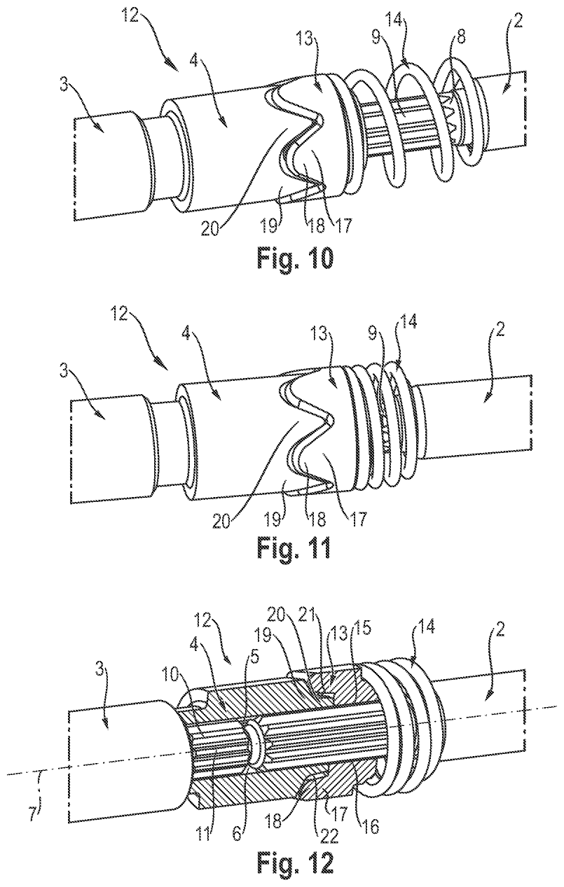

FIGS. 7 to 12 show various views of an assembly 12 for a brake booster for example, for an electromechanical brake booster.

In contrast to the assembly 1 according to FIGS. 1 to 6, the assembly 12 additionally has a centring element 13 for centring and/or aligning the motor output shaft 2 and the transmission input shaft 3 with respect to one another, as well as a spring element 14.

With respect to the centre axis 7, the centering element 13 is arranged substantially between the motor output shaft 2 and the coupling element 4 in the axial direction. The centring element 13 is designed as a centering sleeve and has an axial through-hole 15 with internal toothing 16, which can be operatively connected or is operatively connected to the motor output shaft 2.

The internal toothing 16 of the centering element 13 is spline toothing extending in the axial direction with respect to a centre axis 7. The internal toothing 16 of the centering element 13 has a multiplicity of tooth elements which, with respect to the centre axis 7, extend radially inwards in the radial direction in each case from a tooth root to a tooth tip and are of substantially trapezoidal and/or triangular design in cross section. The internal toothing 16 of the centring element 13 is of complementary design to the external toothing 9 of the motor output shaft 2 and is in engagement or can be brought into engagement with the external toothing 9 of the motor output shaft 2. The end section 8 of the motor output shaft 2 having the external toothing 9 can be passed or is passed through the through-hole 15 of the centering element 13, for example if the spring element is displaced and/or compressed in the axial direction counter to its spring force by the centering element.

The centering element has a centering structure 18 in an axial end region 17. In an axial end region 19, the coupling element 4 has a counter-centring structure 20 which interacts with and corresponds to the centering structure 18 of the centering element 13. The centering structure 18 and the counter-centering structure 20 can engage in one another substantially in the axial direction and, for this purpose, have a tooth structure and/or wedge structure. The centering structure 18 and the counter-centering structure 20 are designed to effect centering and/or alignment in the radial and/or axial direction and/or in the circumferential direction. The centering structure 18 furthermore has an inside diameter 21, and the counter-centering structure 20 furthermore has an outside diameter 22. The inside diameter 21 of the centering structure 18 and the outside diameter 22 of the counter-centering structure 20 are designed to effect centring and/or alignment in the radial direction.

With respect to the centre axis 7, the spring element 14 is arranged effectively between the centering element 18 and the motor output shaft 2 in the axial direction. The spring element 14 is designed as a helical spring and is supported, on the one hand, on a shoulder of the motor output shaft 2 and, on the other hand, on the centering element 13. The spring element 14 is designed to make the centering element 13 project partially beyond the end section 8 of the motor output shaft 2, with the result that, in an initial position, the end section 8 of the motor output shaft 2 does not project beyond the centering element 13, or does not project completely through it, in the axial direction. Only when the spring element 14 is compressed in the axial direction counter to the spring force, for example when the centering element 13 and the coupling element 4 and/or the transmission input shaft 3 and the motor output shaft 2 are brought together, does the end section 8 of the motor output shaft 2 pass through the centering element 13 in the axial direction and come into optimum engagement with the internal toothing 6 of the coupling element 4.

In other respects, reference is additionally made, for example, to FIGS. 1 to 6 and the associated description.

In particular, “can” denotes optional features of the disclosure. Accordingly, there are also developments and/or exemplary arrangements of the disclosure that have the respective feature or features in addition or as an alternative.

If required, isolated features can also be selected from the combinations of features disclosed here and, breaking up a structural and/or functional relationship which may exist between said features, can be used in combination with other features to delimit the subject matter of a claim.

1. An assembly for a brake booster, comprising a motor output shaft an electric motor, a transmission input shaft of a transmission which can be coupled to the electric motor, and a coupling element for power-transmitting coupling of the motor output shaft to the transmission input shaft, wherein the coupling element has internal toothing which can be operatively connected or is operatively connected to the motor output shaft and to the transmission input shaft.

2. The assembly according to claim 1, wherein the motor output shaft has external toothing at least in some section or sections and/or the transmission input shaft has external toothing at least in some section or sections, wherein the external toothing of the motor output shaft and/or the external toothing of the transmission input shaft are/is designed to be complementary to the internal toothing of the coupling element.

3. The assembly according to claim 2, wherein the internal toothing of the coupling element is in engagement or can be brought into engagement with the external toothing of the motor output shaft and/or the external toothing of the transmission input shaft.

4. The assembly according to claim 1, wherein the coupling element and/or its internal toothing are/is designed to transmit a moment from the motor output shaft to the transmission input shaft.

5. The assembly according to claim 1, wherein the coupling element is designed as a sleeve having an axial through-hole, wherein the internal toothing is arranged in the through-hole.

6. The assembly according to claim 5, wherein the transmission input shaft has an end section which has external toothing and can be introduced or is introduced at least partially into the through-hole (5) of the coupling element.

7. The assembly according to claim 5, wherein the motor output shaft has an end section which has external toothing and can be introduced or is introduced at least partially into the through-hole of the coupling element.

8. The assembly according to claim 1, wherein the coupling element is arranged substantially between the motor output shaft and the transmission input shaft in an axial direction.

9. The assembly according to claim 1, wherein the assembly comprises a centering element for centering and/or aligning the motor output shaft and the transmission input shaft with respect to one another.

10. The assembly according to claim 9, wherein the centering element is arranged substantially between the motor output shaft and the transmission input shaft in the axial direction, in particular substantially between the motor output shaft and the coupling element or substantially between the transmission input shaft and the coupling element.

11. The assembly according to claim 9 wherein, the centering element has internal toothing, which can be operatively connected or is operatively connected to the motor output shaft to the transmission input shaft.

12. The assembly according to claim 11, wherein the internal toothing of the centering element is in engagement or can be brought into engagement with external toothing the motor output shaft or with the external toothing of the transmission input shaft.

13. The assembly according to claim 11, wherein the internal toothing of the centering element of complementary design to the external toothing of the motor output shaft and/or the external toothing of the transmission input shaft and/or to the internal toothing of the coupling element.

14. The assembly according to claim 9, wherein the centering element is designed as a sleeve having an axial through-hole, wherein the internal toothing is arranged in the through-hole.

15. The assembly according to claim 14, wherein an end section of the motor output shaft having external toothing can be passed or is passed through the through-hole of the centering element, or an end section of the transmission input shaft having external toothing can be passed or is passed through the through-hole of the centering element.

16. The assembly according to claim 9, wherein the centering element has a centering structure, and the coupling element has a counter-centering structure, which interacts with and/or corresponds to the centering structure of the centering element.

17. The assembly according to claim 16, wherein the centering structure and the counter-centering structure are designed to effect centering and/or alignment in a radial and/or axial direction and/or in a circumferential direction.

18. The assembly according to claim 16, wherein the centering structure and the counter-centring structure engage in one another substantially in an axial direction.

19. The assembly according to claim 16, wherein the centering structure and/or the counter-centering structure have/has a tooth structure and/or wedge structure, wherein the tooth structure and/or wedge structure are/is designed to effect centering and/or alignment in an axial direction and/or in a circumferential direction.

20. The assembly according to claim 16, wherein the centering structure has an inside diameter, and the counter-centering structure has an outside diameter, wherein the inside diameter of the centering structure and the outside diameter of the counter-centering structure are designed to effect radial centering and/or alignment.

21. The assembly according to claim 9, wherein a spring is arranged effectively between the centering element and the motor output shaft in an axial direction, or a spring element is arranged effectively between the centering element and the transmission input shaft in the axial direction.

22. (canceled)
